(19) United States
(12) Patent Application Publication
(10) Pub. No.: US 2007/0265015 A1
(43) Pub. Date: Nov. 15, 2007

(54) Group Call Service In A Cellular Mobile System

(75) Inventor: Mikael Lagerman, Goteborg (SE)

Correspondence Address: ERICSSON INC., 6300 LEGACY DRIVE, M/S EVR 1-C-11, PLANO, TX, 75024, US

(73) Assignee: Telefonaktiebolaget LM Ericsson, Stockholm (SE)

(21) Appl. No.: 11/576,786

(22) PCT Filed: Oct. 6, 2004
(86) PCT No.: PCT/SE04/01419

§ 371 Date: Apr. 5, 2007

(51) Int. Cl. H04Q 7/20

(52) U.S. Cl. 455/452.1

(57) ABSTRACT

The invention refers to traffic controller in a cellular radio system comprising at least one radio base station (BTS) associated with a plurality of traffic channels (T) for serving a cell (C1), and a plurality of mobile stations (MS) within the cell. The traffic controller is arranged to delicate one of the downlink traffic channels (TCHdl1) for a selected group of mobile stations (MS) and is also arranged to delicate one of the uplink traffic channels (TCHul1) for the selected group of mobile stations (MS). Each of the mobile stations (MS1-MS3) in the selected group of mobile stations comprises communication means for inter group communication via the delicated downlink channel (TCHdl1) and the delicated uplink channel (TCHul1) only.

### TECHNICAL FIELD

The invention refers to a traffic controller in a cellular radio system comprising at least one radio base station associated with a plurality of traffic channels for serving a cell, and a plurality of mobile stations within the cell. A number of the traffic channels are dedicated for downlink communication and a number of traffic channels are dedicated for uplink communication. The invention also refers to a method for establishing a group call in a cellular radio system.

### BACKGROUND ART

Radio access offers subscribers a number of radio channels for communication. However, radio channels are in short supply. To effectively utilise the frequency spectrum allocated for use by mobile subscribers (mobile stations), every radio channel should be reusable, which requires well-defined and separate geographical areas that have access to a range of frequencies. Such areas of service are referred to as cells. The nomenclature has given rise to the term cellular system.

Each cell is operated by a base station in the form of a transceiver comprising an antenna that may transmit and receive signals to and from one or several mobile stations in the cell. The traffic to and from the mobile stations is managed by a traffic controller that controls when the base station shall transmit and receive, and when the mobile station shall transmit and receive.

The number of radio channels in a cell is significantly less than the number of mobiles, since—in the normal case—only a minority of the mobiles are active at the same time. The technique used to assign idle traffic channels to calling or called mobiles is referred to as multiple access. Today there are three types of multiple access techniques; TDMA (Time Division Multiplex Access), FDMA (Frequency Division Multiplex) and CDMA (Code Division Multiplex).

With TDM (Time Division Multiplex), eight time slots in a frame are carried by a single frequency channel. There is one frequency channel for uplink (mobile to base station) and one frequency channel for downlink (base station to mobile). Each time slot for each frequency defines a traffic channel that may be used for the uplink and downlink respectively. The traffic channel for downlink is separated in time by one or several time slots from the traffic channel for uplink in order to give the radio unit in the mobile station time to switch between uplink and downlink. However, at any particular instant, several mobiles may use the same time slot but on different frequency channels. On one of the frequency channels, two time slots in each cell are reserved for signalling. If there are more than two frequency channels in the cell, additional control channels on different frequency channels are common. The technique for allocating a time slot to a call is called time division multiple access (TDMA).

Frequency division multiple access (FDMA) is the technique normally used by analog mobile telephone systems, such as NMT and AMPS.

The frequency range assigned to the cell consists of one uplink and one downlink. The frequency separation between these links must be sufficiently large—normally 45 MHz (duplex separation)—so that no interference between them will arise at the mobile.

Each link is divided into an equal number of unidirectional traffic channels. One channel should be sufficiently wide (25-30 kHz) to be able to transmit telephone-quality voice (approximately 3 kHz). To be able to make use of duplex telephony, the mobile must have access to one uplink and one downlink traffic channel—two channels combined to form a traffic channel pair.

Code division multiple access (CDMA) systems are not divided into frequencies, nor are they divided into time slots. All mobiles are capable of transmitting and receiving over the entire frequency band. Instead, a “third dimension” is used to separate traffic channels, namely coding. A typical feature of the CDMA technique is that all mobiles in the network are assigned a unique code: a chip sequence. When a mobile wishes to transmit a bit stream, it replaces every bit with its code or with the code's complement.

Mobile communication systems such as; GPRS (General Packet Radio Service) supporting, for example, GSM (Global System for Mobile communication) and UMTS (Universal Mobile Telecommunications System); or mobile communication systems such as CDMA2000 or IS95; i.e. 2G 2.5G, 3G and 3GPP etc, all use one of the techniques mentioned above.

Common for all techniques is the use of the radio channels for communication in the form of voice call or data transmission.

The channels in a mobile network are divided into two primary groups: control channels and traffic channels.

Every cell employs at least one channel as a control channel, on which the base station continuously transmits an identifying signal that is used by the mobiles to lock into that particular cell. Control channels are also used for paging calls; if the called mobile is in the cell, it will respond over the same (or another) channel. The number of control channels in a cell varies as a function of the access technique employed and the expected call intensity.

After having completed call connection signalling, the mobile is assigned another channel—a traffic channel—for the call. The number of traffic channels in a cell varies with the cell's expected traffic intensity.

Control channels and traffic channels are also referred to as logical channels. These logical channels are mapped onto physical channels.

A physical channel can be a radio broadcasting frequency, a pair of frequencies (including duplex separation) in an analog mobile system or a time slot on a pair of frequencies in a digital mobile system.

In a cellular mobile communication system it is sometimes desirable to arrange group calls between several mobile stations. When arranging a group call the traffic controller dedicates to each participant (mobile station) a certain channel for downlink and a certain channel for uplink. When all participants have been dedicated their channels and the group call have been established, each participant can listen and talk dependent on decision from the traffic controller.

One disadvantage in traditional group calls is the limitation from the number of available traffic channels per cell. For example, if only one frequency channel is available in the serving cell in a TDMA based system, there can be a maximum of six participants since the first two channels are dedicated to control handling. One way of extending the group call would be to change the system by adding more frequency channels, but this is a costly task and will ultimately not rectify the problem since each telephone operator is restricted to a frequency band and thus a number of frequency channels and traffic channels, and this will at the end restrict the number of participants.

There is thus a need for an improved group call service enabling more participants in a group call by use of the existing telephone system.

### DISCLOSURE OF INVENTION

The object of the present invention is to rectify the above problems and to find an improved group call service. The invention refers to a traffic controller in a cellular radio system comprising at least one radio base station associated with a plurality of traffic channels for serving a cell, and a plurality of mobile stations within the cell. A number of the traffic channels are dedicated for downlink communication and a number of traffic channels are dedicated for uplink communication. The traffic controller is arranged to dedicate one of the downlink traffic channels for a selected group of mobile stations. The traffic controller is also arranged to dedicate one of the uplink traffic channels for the selected group of mobile stations. Each of the mobile stations in the selected group of mobile stations comprises communication means for inter group communication via the dedicated downlink channel and the dedicated uplink channel only. The selected group of mobile stations may in the following text be labelled participants.

One advantage of the present invention is that the number of participants in the group call will not be restricted by the limitation of the number of channels. One further advantage is that even though a group call is established, there are a number of traffic channels available for either more group calls or normal communication from single users (mobile stations).

In one embodiment of the invention, the selected group of mobile stations each have means for establishing the dedicated uplink channel and the dedicated downlink channel. This may be accomplished by a number of different ways:

In one embodiment, each mobile station may comprise a pre-programmed list of participants and when there is a need for a group call a request is sent to the traffic controller. The request may comprise the list of participants or the traffic controller may already have a copy of the list. The traffic controller then transmits a signal to all mobile stations in the list and directs them all to one downlink channel and one uplink channel. After a certain time out period or after reply from a preset number of users, the traffic controller decides that a group call has been established.

In another embodiment, each mobile station may comprise a pre-programmed request flag or command which is transmitted to the traffic controller when requesting a group call. When the traffic controller receives request, the traffic controller uses a pre-determined list of participants and transmits a signal to all mobile stations in the list and directs them all to one downlink channel and one uplink channel. After a certain time out period or after reply from a preset number of users, the traffic controller decides that a group call has been established.

In another embodiment, a mobile station may require a group call and the traffic controller sends an invitation to all mobile stations within the cell. The mobile station or the mobile station handler may then decide whether he wants to participate or not, and accepts the invitation by submitting a acceptance flag or acceptance command to the traffic controller. The traffic controller then establishes group call by directing all participants to one downlink channel and one uplink channel.

In another embodiment, a mobile station may require a group call and the traffic controller sends a command to all mobile stations within one or several cells. The mobile station or the mobile station handler may then decide whether he wants to participate or not, and declines the invitation by submitting a non-acceptance flag or non-acceptance command to the traffic controller. The traffic controller establishes the group call by directing all participants to one downlink channel and one uplink channel.

In another embodiment, a dispatcher in a network may decide that a group call shall be established and what participants shall be part of what group. The dispatcher may be an operator in an operative central and may be found anywhere in the network. The network may be a part of the Internet or the like and may comprise a number of land-line based systems as well as a number of mobile radio systems.

In one embodiment of the invention, the group call is not restricted to a single cell, but may comprise participates in a number of cells. Each cell is controlled according to the invention, i.e. each traffic controller for each cell dedicates one uplink and one downlink channel for the participants occupying the respective cell. However, one traffic controller may control a number of cells, but the traffic controller dedicates one uplink and one downlink channel per cell for all the participants occupying the respective cell.

In the case where a number of traffic controllers control a number of cells a mobile switching center governs the traffic controllers and may be used to control the traffic controls to dedicate suitable traffic channels in the different cells. The mobile switching center is also used for creating a route (a connection) in order to enable participants in one cell to communicate with participants in another cell.

In one embodiment of the invention the traffic controller may divide the participants in one cell into subgroups of participants. The traffic controller then dedicates one uplink channel and one corresponding downlink channel for each subgroup.

In one embodiment of the invention, the dedicated downlink channel is dedicated to a broadcast service. This enables all participants in the group call to hear the communication between two designated participants, i.e. two mobile stations or one mobile station and a dispatcher. The broadcast service has the benefit that an unlimited number of participants can join the group call as long as they all can listen to the same dedicated downlink traffic channel.

In one embodiment of the invention, the traffic controller is arranged to allow communication from one mobile station at a time from the selected group of mobile stations, via the dedicated uplink channel. Each mobile station needs to request and to be granted permission to transmit on the dedicated uplink traffic channel by the traffic controller before the mobile station can address the rest of the group of mobile stations. The setup for the mobile station communication may comprise a number of different routines. The benefit of this embodiment is that an unlimited number of participants can join the group call as long as they all can listen to the dedicated downlink traffic channel and transmit on the dedicated uplink traffic channel.

According to one routine, the mobile station requests permission to talk by sending a request to the traffic controller. This may be done by a so-called “push-to-talk” function, where the handler of the user unit presses a designated button on the mobile station, wherein the request is transmitted. When the traffic controller has received the request, the traffic controller makes a decision based on a pre-programmed scenario whether or not to allow the mobile station to transmit on the broadcast channel.

One scenario is that the traffic controller puts the mobile station in a listening mode and in a queue for transmitting. The queue system may be based on different priorities designated to certain mobile stations, for example, when the mobile station is a dispatcher or a chief in command. The queue system may also be based on a chronological algorithm where the mobile stations are put in a chronological stack. The queue system may also comprise an algorithm where mobile stations are deleted from the queue after a certain time out period. The queue system may also be based on an algorithm where a mobile station sending a number of requests. within a certain time period gets a higher priority or may even interrupt the call in progress. In all scenarios based on a queue system or the like, the traffic controller sends an acceptance flag or command to the mobile station allowed to transmit. The handler of the selected mobile station may be alerted by a light or a sound signal, or any other suitable signal, that transmission is allowed.

Another scenario is that the traffic controller breaks the communication in progress upon request from a mobile station. This scenario relies on a high degree of radio discipline and it is assumed that if a mobile station sends a request during a call in progress, the handler listening to the call in progress has made a decision that the handler's call is of greater importance than the ongoing call, why the call in progress should be interrupted. In this scenario, the handler of the mobile station needs only to push a communication button and start the transmission. In this scenario the mobile station does not need to wait for acceptance from the traffic controller.

The traffic controller may also base its decision on a number of other scenarios or criteria. However, the common feature for all feasible scenarios is that the traffic controller is arranged to select only one mobile station at a time for uplink transmission from the selected group. The uplink transmission on the dedicated uplink channel from the selected mobile station is then transmitted to all mobile stations in the group call via the dedicated downlink channel.

One advantage of the invention is that multiple mobiles in one cell use the same traffic channel for uplink and the same traffic channel for downlink. This will require modification of the traffic controller in a radio system already present, but the mobile station do not have to be modified. The use of the shelf mobile stations (for example mobile telephones) is an essential benefit. However, the mobile stations of today may be modified by implementing software for supporting the group call service according to the invention. Most shelf mobile stations are equipped with a programmable unit that may be programmed manually or by transmission of a program from a network associated with the radio system. The traffic controller of today also comprises a programmable unit that that may be programmed manually or by transmission of a program from a network associated with the radio system.

In order to implement the invention according to any of the above embodiments in existing radio systems, software supporting the group call service is downloaded on the traffic controller and software may also be downloaded on each of the mobile stations. It is a cost efficient advantage that only software needs to be implemented instead of changing part of or the entire hardware.

The invention gives a cost efficient means for an operator to offer services to, for example, the city fire department etc. without having to increase the present network capacity. Furthermore, the impact while the group call is in use on other users would be neglectable. This means that the users occupying the main part of the available channels can maintain their channels during establishment of a group call, since the group call according to the invention is using only one channel for downlink and one cannel for uplink. In previously known systems the main part of the users were thrown out from the system when establishing a group call.

To sum up the inventive idea, a dispatcher or a group call initiator initiates a new group. The members are identified by phone numbers or by predefined groups. The request may, for example, be uploaded via a GPRS or SMS request to a network.

One traffic channel for upload and one for download is requested in each cell that has at least one group member present. The channels in the different cells may then be connected into a conference call session.

The major difference from a traditional multichannel group call is that there is only one uplink per participating cell and one downlink channel per participating cell. The participants therefore have to request the uplink traffic channel (for example via a PTT procedure) from the traffic controller. This will require modification of the current traffic controller design according to above.

The group call session remains established during the extent of the group task lifetime. Furthermore, additional participants may be added at any time during the group call session.

It is also possible to split/fork a new group from an active group. The new group is dedicated a new downlink channel and a new uplink channel. This enables, for example, a main police channel to form a dedicated group for a regional task.

### BRIEF DESCRIPTION OF DRAWINGS

The invention will below be described in connection to a number of drawings, where;

FIG. 1 schematically shows a flow chart of a cellular radio system according one embodiment of the invention;

FIG. 2 schematically shows a channel distribution according to a first embodiment of the invention in a TDMA system, and where;

FIG. 3 schematically shows a channel distribution according to a second embodiment of the invention in a TDMA system.

### EMBODIMENTS OF THE INVENTION

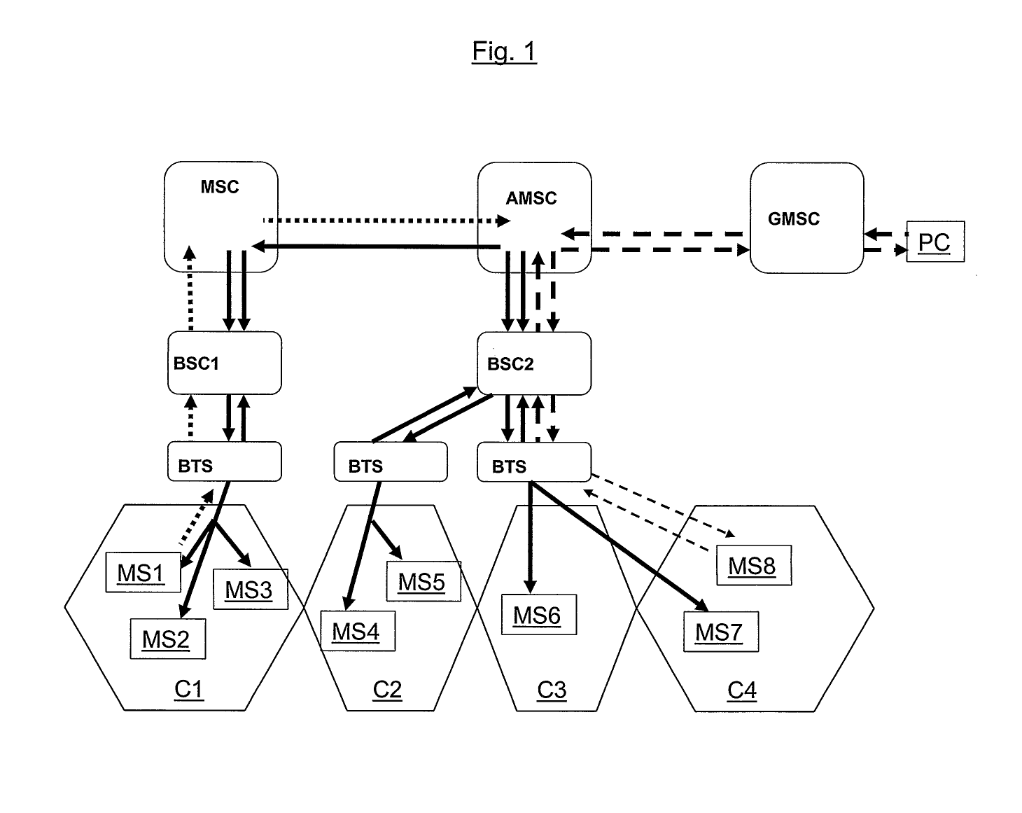

FIG. 1 schematically shows a flow chart of a cellular radio system according one embodiment of the invention in a TDMA based system comprising, for example, GPRS supported functions such as GSM and 3GPP. The radio system comprises:
MS: A mobile station that can be a mobile telephone, a fax having radio access or a laptop computer equipped with a radio modem.
BTS: A base transceiver station that contains equipment for transmission and reception, antennas for one or more cells, plus equipment for encryption/decryption and signal strength measurement and for communication with the BSC.
BSC: A base station controller, also referred to as the traffic controller, that sets up the radio channels for traffic and for signalling to the MSC and monitors the access network portion of the connection. A BSC also performs traffic concentration and handles handover between the base stations that it controls. BSCs are only found in the GSM standard. In other standards, the MSC also handles radio switch functions.
MSC: A mobile switching centre that is a switching node having the specialised functions required by mobile networks, notably those relating to handover between MSCs and between different PLMNs (Public Land Mobile Networks). An MSC can be likened to the local exchange of a fixed network, although it does not have any fixed subscribers (at least not in the case of GSM). A PLMN can have one or several MSCs, depending on the size of the network and the number of subscribers. The cells whose base stations are controlled by a particular MSC constitute an MSC service area.
A gateway MSC (GMSC) is a specialised MSC that serves as an interface to other networks, for example comprising PCs (personal computers). All connections to and from mobile networks pass through a GMSC (more than one unit can be found within one and the same network). A GMSC does not need to handle subscriber data but must be capable of handling different signalling standards for its communication with other networks. Charging and settlement of accounts between networks are also functions of the GMSC. A GMSC represents a mobile network vis-à-vis other networks. Fixed-network connections are performed at the national or international level of the PSTN/ISDN, where a PLMN can be identified in the same manner as any other operator network.

In FIG. 1 the BSC1 has been modified to enable allocating multiple mobiles MS1-MS3 in the same cell C1 to listen to the same dedicated downlink traffic channel TCHdl1. In FIG. 1 the BSC2 has been modified to enable allocating multiple mobiles MS4 and MS5 in cell C2 to listen to the same dedicated downlink traffic channel TCHdl2, and mobile MS6 in cell C3 to listen to a dedicated downlink traffic channel TCHdl3 and MS7 and MS8 in cell C4 to listen to a dedicated downlink traffic channel TCHdl4. All the downlink channels TCHdl1-TCHd14 are dedicated to a broadcast function such that all mobile stations MS1-MS8 can listen to the same transmission. In FIG. 1 the broadcast function is depicted with unbroken lines with arrows pointing in the propagation direction of the signal.

In FIG. 1 the BSC1 has been modified to enable allocating multiple mobiles MS1-MS3 in the same cell C1 to be able to transmit on the same dedicated uplink traffic channel TCHul1. In FIG. 1 the BSC2 has been modified to enable allocating multiple mobiles MS4 and MS5 in cell C2 to be able to transmit on the same dedicated uplink traffic channel TCHul2, and mobile MS6 in cell C3 be able to transmit on the dedicated uplink traffic channel TCHul3, and MS7 and MS8 in a cell C4 be able to transmit on the same dedicated uplink traffic channel TCHul4. In order for the mobile stations M1-M3 to transmit on their dedicated uplink channel TCHul1, each mobile station MS1-MS3 has to request allowance to transmit from the traffic controller BSC1. In order for the mobile stations M4-M8 to transmit on their dedicated uplink channels TCHul2-TCHul4, each mobile station MS4-MS8 has to request allowance to transmit from the traffic controller BSC2.

In FIG. 1 a group call anchor Mobile Switching Center (MSC) denoted AMSC is responsible for the scheduling of the traffic controllers BSC1 and BSC2, when setting up the transmission from dedicated mobile stations. This is to avoid that BSC1 allows transmission simultaneously as BSC2, which would cause an interference problem on the dedicated downlink channels TCHdl1-TCHdl4 if two mobile stations would transmit simultaneously. However, different mobile stations in different but adjacent cells utilising different frequencies, may be allowed to transmit simultaneously, for example MS1 and MS 5 can be allowed to transmit simultaneously, but MS1 and MS2 cannot. This is also true for mobile stations in non adjacent cells, for example MS1 and MS8 (see dotted arrows in FIG. 1), using the same frequencies. However, if a number of mobile stations in different cells are allowed to uplink simultaneously, the traffic controller comprises means for handling this situation. For example, the traffic controller may allow simultaneous broadcast or may disregard from all but one mobile station.

The AMSC also routes the transmitted signal from a transmitting mobile station to the dedicated downlink channels TCHdl1-TCHdl4 enabling all participants MS1-MS8 to listen to the uplink signal from the dedicated mobile station. The uplink signal is thus forwarded up in the system until a suitable part of the system, for example the AMSC, allows broadcast of the signal on all downlink channels dedicated to the group call. In FIG. 1 BSC1 is connected to a relay MSC that relays information from the BSC1 to the AMSC and vice versa. The relay MSC may be arranged to govern the BSC1 dependent on information from the AMSC in order to synchronize the transmission from different mobile stations MS1-MS8 and other units PC in a network connected to the radio network via the GMSC. The AMSC may be labelled as a traffic controller for a group call comprising a number of BSC:s since the AMSC governs the different BSC:s and may be the deciding part when setting up the group call. However, the BSC is labelled as the traffic controller for the group call in a cell.

In FIG. 1 MS1 has been granted by the traffic controller BTS1 to transmit information to the group MS2-MS8 on the uplink traffic channel TCHul1. In FIG. 1 the transmission from MS1 is depicted with a broken line with an arrow pointing in the propagation direction of the signal.

In FIG. 1 the transmitted uplink signal from MS1 reaches the MSC and the AMSC. The AMSC routes the transmitted signal to the dedicated downlink channels TCHdl1-TCHdl4 enabling all participants MS2-MS8 to listen to the uplink signal from the MS2.

Furthermore, in FIG. 1 MS8 is allowed to transmit at another time interval than MS1 enabling a communication between MS1 and MS8. The communication can be heard by all members MS1-MS8 in the group call.

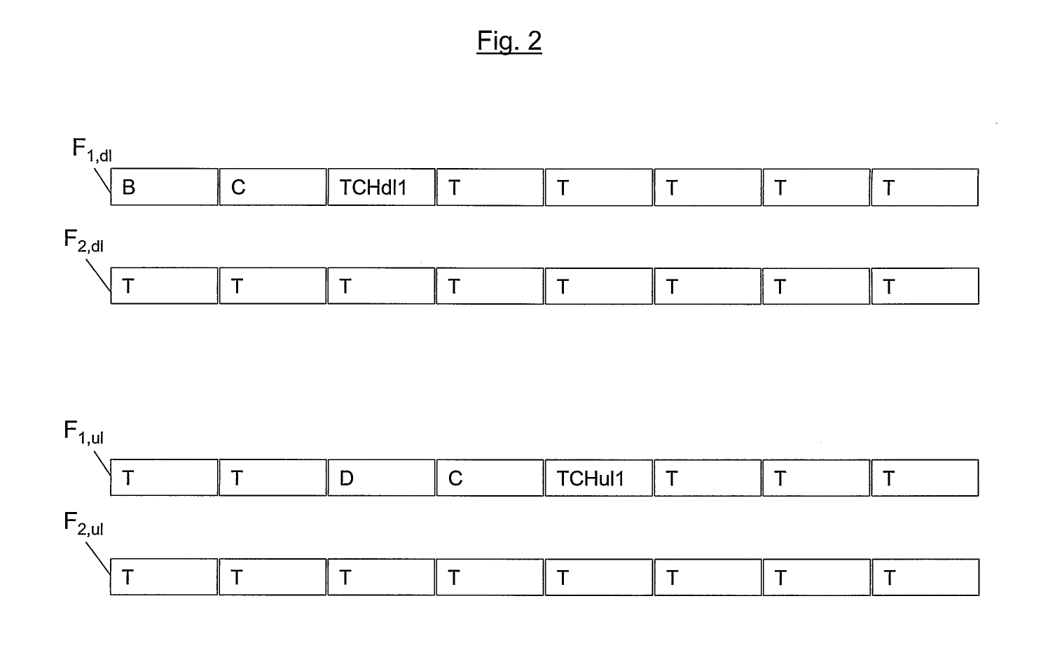

FIG. 2 schematically shows a channel distribution according to a first embodiment of the invention in a TDMA system. The system is using two frequency channels F_{1,dl} and F_{2,dl} for downlink and two frequency channels F_{1,ul} and F_{2,ul} for uplink. The dedicated downlink channel TCHdl1 and the dedicated uplink channel TCHul1, mentioned above in connection to FIG. 1, are present in the first set of frequency channels F_{1,dl} and F_{1,ul} respectively. The first frequency channel for downlink F_{1,dl} comprises channels B and C intended to be used for broadcast B and control C signals. The broadcast channel B is used for giving all mobile stations in the cell information on the location of the base station. The control channel C is used for control signalling and may be used when setting up the group call by signalling to all participants in the cell which dedicated channel should be used for downlink and which channel should be used for uplink. In a GSM based system the downlink channel and the uplink channel work in pairs, i.e. each downlink channel has a corresponding uplink channel. The second frequency channel for downlink F_{2,dl} comprises only traffic channels T. The first frequency channel for uplink F_{1,ul} comprises channel C intended to be used for control signals, and a channel D corresponding to channel B and that may be used for a number of different purposes, for example signalling. The second frequency channel for uplink F_{2,ul} comprises only traffic channels T.

FIG. 2 shows that the downlink channel TCHdl1 is separated in time from the uplink channel TCHul1 by a time interval of one traffic channel T. The separation in time between the channels can be more than one traffic channel T, dependent on certain parameters, for example, interference, etc. This is however normally a fixed matter established in the standard, for example in the GSM. The frequency distribution according to FIG. 2 may be the frequency distribution in cell C1 in FIG. 1, but the same frequency distribution may be used in the other cells C2-C4 comprised in the group call. However, the adjacent cells may dedicate different traffic channels in time or different frequencies in order to avoid interference problem.

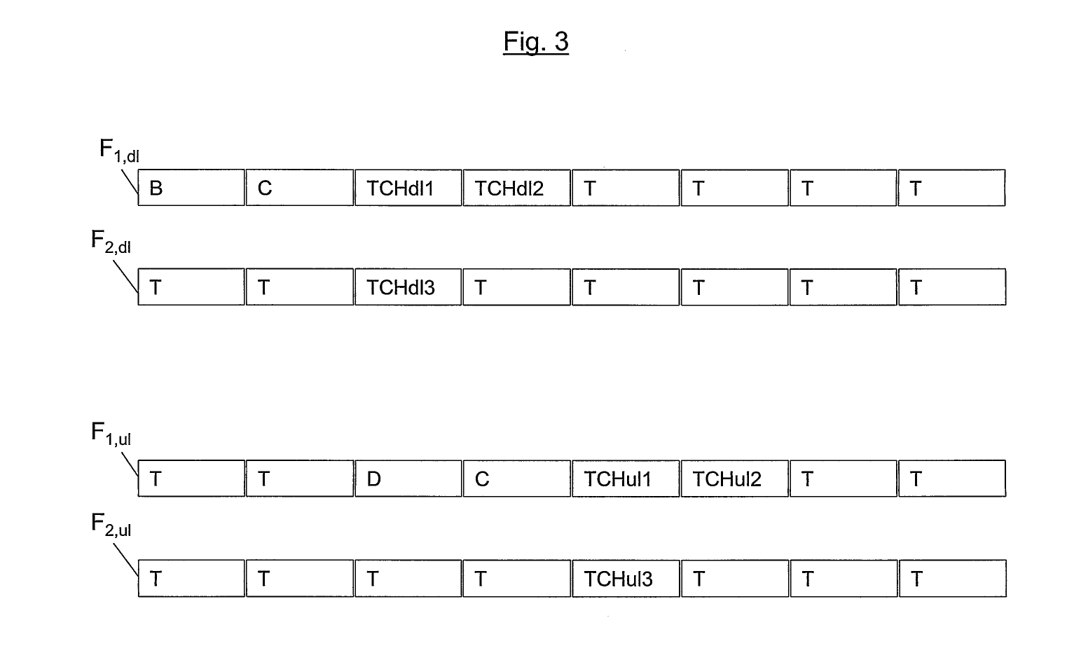

FIG. 3 schematically shows a channel distribution according to a second embodiment of the invention in a TDMA system. The channel distribution is identical to the channel distribution in FIG. 2. The system is thus using two frequency channels F_{1,dl} and F_{2,dl} for downlink and two corresponding frequency channels F_{1,ul} and F_{2,ul} for uplink. The dedicated downlink channel TCHdl1 and the dedicated uplink channel TCHul1, mentioned above in connection to FIG. 1, are present in the first set of frequency channels F_{1,dl} and F_{1,ul}. In FIG. 3, there is also dedicated downlink channel TCHdl2 and a corresponding dedicated uplink channel TCHul2 in the first set of frequency channels F_{1,dl} and F_{1,ul} and also dedicated downlink channel TCHdl3 and a corresponding dedicated uplink channel TCHul3 in the second set of frequency channels F_{2,dl} and F_{2,ul}. The corresponding traffic channels TCHdl1 and TCHul1 are used for one group call, and the corresponding traffic channels TCHdl2 and TCHul2 are used for a second group call, and the corresponding traffic channels TCHdl3 and TCHul3 are used for a third group call. The second frequency channel for downlink F2_{,dl} comprises only traffic channels T. The second frequency channel for uplink F2_{,ul} comprises only traffic channels T.

FIG. 3 shows that the downlink channels TCHdl1, TCHdl2, TCHdl3 are separated in time from the corresponding uplink channels TCHul1, TCHul2, TCHul3 by a time interval of one traffic channel T. The separation in time between the channels can be more than one traffic channel T, dependent on certain parameters, for example, interference, etc. The frequency distribution according to FIG. 2 may be the frequency distribution in cell C1 in FIG. 1, but the same frequency distribution may be used in the other cells C2-C4 comprised in the group call, at least in a GSM based system. However, the adjacent cells are preferably using different frequencies in order to avoid interference problem. This means that the same or different channels in time may be dedicated to mobile stations in adjacent cells.

The invention is not limited to the above embodiments, but may be varied within the scope of the claims. For example, the radio system may use a CDMA or FDMA technique, or another technique that uses a limited number of traffic channels for supporting mobile stations in a cell.

1. A traffic controller in a cellular radio system comprising at least one radio base station associated with a plurality of traffic channels for serving a cell, the system comprising a plurality of mobile stations within the cell, a number of the traffic channels are dedicated for downlink communication and a number of traffic channels are dedicated for uplink communication, characterized in that the traffic controller is arranged to dedicate one of the downlink traffic channels for a selected group of mobile stations and wherein the traffic controller is arranged to dedicate one of the uplink traffic channels for the selected group of mobile stations.

2. A cellular radio system according to claim 1, characterized in that each mobile station, belonging to the selected group of mobile stations each have means for establishing the dedicated downlink channel by a request to the traffic controller.

3. A cellular radio system according to claim 1 characterized in that the dedicated downlink channel is dedicated to a broadcast service.

4. A cellular radio system according to claim 1, characterized in that the traffic controller is arranged to allow communication from one mobile station at a time from the selected group of mobile stations, via the dedicated uplink channel.

5. A cellular radio system according to claim 4, characterized in that the traffic controller is arranged to select the one mobile station from the selected group of mobile stations dependent on a predetermined scenario.

6. A method for establishing a group call in a cellular radio system comprising a traffic controller and at least one radio base station associated with a plurality of traffic channels for serving a cell comprising a plurality of mobile stations, wherein a number of the traffic channels are dedicated for downlink communication and a number of traffic channels are dedicated for uplink communication; wherein the method comprises:
the traffic controller dedicating one of the downlink traffic channels for a selected group of mobile stations; and,
the traffic controller dedicating one of the uplink traffic channels for the selected group of mobile stations.

7. A method according to claim 6, wherein the selected group of mobile stations communicates via the dedicated downlink channel and the dedicated uplink channel only.

8. A method according to claim 6, wherein the selected group of mobile stations each establishes the dedicated downlink channel via a request to the traffic controller.

9. A method according to claim 6, wherein the dedicated downlink channel is used as a broadcast service.

10. A method according to claim 6, wherein the traffic controller allows communication from one mobile station at a time from the selected group of mobile stations, via the dedicated uplink channel.

11. A method according to claim 10, wherein the traffic controller selects the one mobile station from the selected group of mobile stations dependent on a predetermined scenario.

12. A method according to claim 6, wherein the uplink transmission on the dedicated uplink channel from the selected mobile station is transmitted to all mobile stations in the group call via the dedicated downlink channel TCHdM.
